(19) United States
(12) Patent Application Publication
(10) Pub. No.: US 2025/0139006 A1
(43) Pub. Date: May 1, 2025

(54) SYSTEMS, METHODS, AND APPARATUS FOR A CACHE DIRECTORY FOR A MULTI-LEVEL CACHE HIERARCHY

(71) Applicant: Samsung Electronics Co., Ltd., Suwon-si (KR)

(72) Inventors: Aditya Madhusudan DESHPANDE, Sunnyvale, CA (US); Douglas JOSEPH, Leander, TX (US); Arun RODRIGUES, Albuquerque, NM (US); Manisha GAJBE, Folsom, CA (US)

(21) Appl. No.: 18/741,764

(22) Filed: Jun. 12, 2024

Related U.S. Application Data
(60) Provisional application No. 63/545,743, filed on Oct. 25, 2023.

(51) Int. Cl. G06F 12/0806

(52) U.S. Cl. CPC G06F 12/0806; G06F 2212/62

(57) ABSTRACT

In some aspects, the techniques described herein relate to a device including a storage media and a processor including a cache hierarchy including a first cache, a second cache, and a third cache, wherein the first cache and the third cache are organized in an inclusive cache hierarchy, and wherein the second cache is an exclusive cache to the inclusive cache hierarchy; and a cache directory, wherein the cache directory corresponds to the first cache, second cache, and third cache. In some aspects, the processor performs operations including searching the first cache for data, searching the second cache for the data, and searching the cache directory for the data. In some aspects, searching the cache directory includes determining that the data is located in the cache directory and determining a location of the data in the cache hierarchy based on an entry in the cache directory.

### REFERENCE TO RELATED APPLICATION

This application claims priority to, and the benefit of, U.S. Provisional Patent Application Ser. No. 63/545,743, filed on Oct. 25, 2023, which is incorporated by reference.

### TECHNICAL FIELD

This disclosure relates generally to memory caches, and more specifically to systems, methods, and apparatus for a cache directory for a multi-level cache hierarchy.

### BACKGROUND

Multi-core processor caches may be architected as a multi-level cache hierarchy. For example, a multi-level cache hierarchy may have multiple caches and use a tier structure to organize the caches in the cache hierarchy. Directories may be used to identify caches that share data and the current state of the data to manage the data in the caches.

The above information disclosed in this Background section is only for enhancement of understanding of the background of the invention and therefore it may contain information that does not constitute prior art.

### SUMMARY

In some aspects, the techniques described herein relate to a device including a storage media and a processor including a cache hierarchy including a first cache, a second cache, and a third cache, wherein the first cache and the third cache are organized in an inclusive cache hierarchy, and wherein the second cache is an exclusive cache to the inclusive cache hierarchy; and a cache directory, wherein the cache directory corresponds to the first cache, second cache, and third cache. In some aspects, the first cache is a first level cache, the second cache is a second level cache, and the third cache is a last level cache. In some aspects, an entry of the cache directory includes an indicator of a cache where data is present in the cache hierarchy. In some aspects, the processor performs operations including searching the first cache for data, searching the second cache for the data, and searching the cache directory for the data. In some aspects, searching the second cache and searching the cache directory are performed in parallel. In some aspects, searching the cache directory includes determining that the data is located in the cache directory and determining a location of the data in the cache hierarchy based on an entry in the cache directory. In some aspects, searching the cache directory includes determining that the data is not found in the cache directory and retrieving data from the storage media. In some aspects, the device further includes a fourth cache, the first cache is a first level cache, the second cache and the fourth cache are second level caches, the third cache is a last level cache, the fourth cache is an exclusive cache, and the processor performs operations including searching the cache directory for data, determining that the data is found in a second level cache, and searching the fourth cache for the data. In some aspects, the device further includes a fourth cache, the first cache is a first level cache; the second cache is a second level cache, the third cache and the fourth cache are last level caches, the fourth cache is organized in the inclusive cache hierarchy, and the processor performs operations including searching the cache directory for data, determining that the data is found in a last level cache, and searching the fourth cache for the data.

In some aspects, the techniques described herein relate to a method implemented by a processor including cache media, wherein the cache media includes a cache hierarchy and a cache directory, and wherein the method includes receiving a request to access data; determining, using the cache directory, that the data is located in the cache hierarchy, wherein the cache hierarchy includes one or more inclusive caches and one or more exclusive caches, and wherein the cache hierarchy is organized in a hierarchy structure; and retrieving the data from the cache hierarchy. In some aspects, the cache hierarchy includes a first level cache, second level cache, and third level cache; and determining that the data is located in the cache hierarchy includes searching the first level cache for the data; searching the second level cache for the data; searching the cache directory for the data; determining, by the cache directory, that the data is located at the third level cache; and searching the third level cache for the data. In some aspects, searching the second level cache and searching the cache directory are performed in parallel. In some aspects, searching the cache directory includes determining that the data is located in the cache directory and determining a location of the data in the cache hierarchy based on the cache directory. In some aspects, the cache directory includes an indicator of a cache where the data is present in the cache hierarchy. In some aspects, the one or more inclusive caches includes a first cache and a third cache, the one or more exclusive caches includes a second cache and a fourth cache, the first cache is a first level cache, the second cache and the fourth cache are second level caches, and determining that the data is located in the cache hierarchy includes searching the first cache for the data; searching the second cache and the cache directory for the data; determining, by the cache directory, that the data is located at a different cache at a second level cache; and searching the fourth cache for the data. In some aspects, determining that the data is located in the cache hierarchy includes searching the cache directory for the data and determining a location of the data based on an indicator of a cache where the data is present in the cache hierarchy.

In some aspects, the techniques described herein relate to a method implemented by a processor including cache media and storage media; wherein the cache media includes a cache hierarchy and a cache directory; and wherein the method includes receiving a request for data; determining, using the cache directory, that the data is not present in the cache hierarchy, wherein the cache hierarchy includes one or more inclusive caches and one or more exclusive caches, and wherein the cache hierarchy is organized in a hierarchy structure; and retrieving the data from the storage media. In some aspects, the cache hierarchy includes a first level cache and a second level cache; and determining that the data is not present in the cache hierarchy includes searching the first level cache for the data; searching the second level cache for the data; and searching the cache directory for the data, wherein the data does not include a corresponding entry in the cache directory. In some aspects, searching the second level cache and searching the cache directory are performed in parallel. In some aspects, searching the cache directory includes determining that the data is not located in the cache directory.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an example embodiment of a multi-level cache with inclusive and exclusive directories in accordance with embodiments of the disclosure.

FIG. 2 illustrates an example embodiment of a multi-level cache with a unified cache directory in accordance with embodiments of the disclosure.

FIG. 3 illustrates an example device including a cache directory in accordance with example embodiments of the disclosure.

FIG. 4 illustrates a flowchart of a method where data is found in a unified cache directory in accordance with example embodiments of the disclosure.

FIG. 5 illustrates a flowchart of a method where data is not found in a unified cache directory in accordance with example embodiments of the disclosure.

FIG. 6 illustrates a flowchart of a method for searching the unified cache directory in accordance with example embodiments of the disclosure.

### DETAILED DESCRIPTION

A cache may be used to improve the overall performance of a processor. For example, a processor can populate data in a cache to respond to future requests for that data faster than if the data was located in storage media. If a processor attempts to access data that is in the cache (e.g., a cache hit), then the data may be retrieved from the cache. If data is not found in the cache (e.g., a cache miss), the data may be retrieved from the slower storage media. If the frequency of cache hits increases, performance may improve since data may be retrieved faster. Generally, a cache can include high-speed memory (e.g., static random access memory (SRAM)) that allows for faster reads and writes compared to slower storage media such as not-and (NAND) memory.

In some embodiments, a multi-core processer may have multiple cores, where each core can perform operations of the processor. In some embodiments, a processor may have multiple levels of cache (e.g., cache hierarchy). For example, in a multi-core processor, each core may have its own cache and/or share a cache between two or more cores (e.g., unified cache). Generally, a processor may have a fast lower-level cache (e.g., level 1 cache) that is backed up by at least one higher-level cache (e.g., level 2 cache). Similarly to cache media and storage media, the processor may check the level 1 cache first for data, and if a cache miss occurs, check the level 2 cache or higher-level cache.

In some embodiments, data may be managed so that data from a lower-level cache (e.g., level 1 cache) is also present on a higher-level cache (e.g., level 2 cache). In some embodiments, this may be considered an inclusive cache hierarchy. In some embodiments, if data is not present on a higher-level cache (e.g., the data is found at a single level of cache), the cache may be considered an exclusive cache to the inclusive cache hierarchy. In some embodiments, in an inclusive cache hierarchy, data present in a cache may also be present in corresponding higher-level caches (e.g., the last-level cache may hold copies of the data present in the lower-level caches of the inclusive cache hierarchy). In some embodiments, as data is copied from storage media to an inclusive cache, the data may be populated at all levels of the inclusive cache hierarchy. Because the data may be populated at multiple levels of cache, an inclusive cache hierarchy may result in a lower effective cache capacity due to data being replicated across cache levels, and latency and energy consumption may increase due to operations on the inclusive cache hierarchy, which will be explained in more detail further below. In some embodiments, some processes, such as tensor processing, may make use of exclusive caches to perform its operations instead of using the inclusive cache hierarchy.

In some embodiments, hardware-based cache coherence may be supported in a multi-core processor. Cache coherence may allow changes to data to be propagated throughout the cache levels to ensure that the data is consistent in multiple caches. Cache coherence need not be hardware-based and may be software-based or a combination of hardware and software. In some embodiments, a directory-based coherence may be used for the hardware-based cache coherence. In some embodiments, for a multi-level cache hierarchy consisting of a combination of inclusive and exclusive caches, a directory may be needed, at least, at every level of exclusive cache and at the end of an inclusive cache hierarchy to correctly track the presence and state of the data across the cache hierarchy.

According to embodiments of the disclosure, a unified cache directory may be used to track the presence and state of the data across the cache hierarchy for inclusive and exclusive caches. For example, when a processor retrieves data, it may check the unified cache directory instead of checking directories at each level of cache, allowing for fewer operations and thus improving the performance of the cache hierarchy.

This disclosure encompasses numerous aspects relating to devices with memory and storage configurations. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as devices implemented as storage devices that may use specific interfaces, protocols, and/or the like. However, the aspects of the disclosure are not limited to these or any other implementation details.

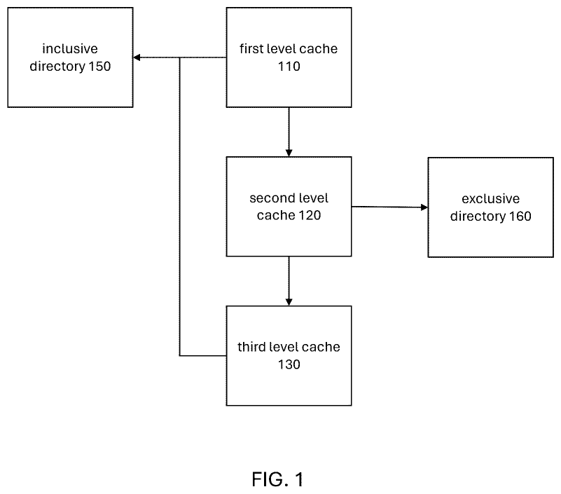

FIG. 1 illustrates an example embodiment of a multi-level cache with inclusive and exclusive directories in accordance with embodiments of the disclosure. In some embodiments, a processor may include a first level cache 110, a second level cache 120, and a third level cache 130 (e.g., last level cache). In some embodiments, the first level cache 110, second level cache 120, and third level cache 130 may be ordered in such a way that, e.g., the first level cache 110 is fast memory, and the second level cache 120 and third level cache 130 are slower memory. In the example illustrated in FIG. 1, the first level cache 110 and third level cache 130 are part of an inclusive cache hierarchy and the second level cache 120 is an exclusive cache to the inclusive cache hierarchy. Although, in FIG. 1, three levels of cache are described for illustrative purposes, there may be many more caches and/or levels of cache.

In some embodiments, the first level cache 110 and third level cache 130 may correspond to an inclusive directory 150. In some embodiments, the second level cache 120 may correspond to an exclusive directory 160. In some embodiments, when data is written to the cache, if the data is written to the second level cache 120, data may be written to the second level cache 120 and not written to the first level cache 110 or third level cache 130. In some embodiments, if data is written to the first level cache 110, the data may also be written to the third level cache 130. Although a single exclusive directory is illustrated, there may be an exclusive directory for each exclusive cache. Furthermore, in some embodiments, there may be other types of directories and caches, for example, a non-exclusive cache or non-inclusive cache.

In some embodiments, when the cache hierarchy is searched for data, the first level cache 110 may be searched. For example, a cache tag lookup may be performed to determine if data is present on the first level cache 110. In some embodiments, if the data is present, the data may be returned from the first level cache 110. In some embodiments, if the data is not present in the first level cache 110, a cache miss may occur. In some embodiments, if a cache miss occurs, the processor may check the second level cache 120 and/or the directory for the first level cache (e.g., inclusive directory 150) for the data. In some embodiments, the operations may be done in serial or in parallel. In some embodiments, if the data is present in the second level cache 120, it may be returned to the user from the second level cache 120. In some embodiments, if the data is not present in the second level cache 120, a directory for the second level cache (e.g., exclusive directory 160) and cache tags for the third level cache 130 may be checked to determine if the data is present in any other second level cache or the third level cache 130. In some embodiments, If the data is present in third level cache 130, the data may be returned from the third level cache. In some embodiments, if the data is not present in the third level cache 130, a main memory request may be issued (e.g., the data is retrieved from storage media). Thus, in the description above, two directory lookups, and second level cache and third level cache tag accesses may be incurred to determine if the data is present in any of the caches in the cache hierarchy.

In some embodiments, the directory structures may be used to track the state of the data present in a cache hierarchy. In some embodiments, in a multi-level cache hierarchy with a combination of inclusive and exclusive caches, a directory structure may be present at each level of an exclusive cache and at the last level of an inclusive cache hierarchy. In some embodiments, the directory structure for a level of the cache hierarchy may correspond to all caches at that level. For example, in the above description of FIG. 1, when data is not present in the second level cache 120, the directory for the second level cache (e.g., exclusive directory 160) may be checked. In some embodiments, the exclusive directory 160 may contain information for other caches at the same level. For example, if the data is not located in the second level cache 120, it may be located in another second level cache, so the exclusive directory 160 for the second level may be checked (e.g., the exclusive directory 160 may contain the location of data in all second level caches).

In some embodiments, the directory structure in FIG. 1 may be for a single multi-core processor. However, it should be understood that the directory structure may be used for multiple processors. For example, if multiple processors share a cache, they may also share the directory structure for that cache.

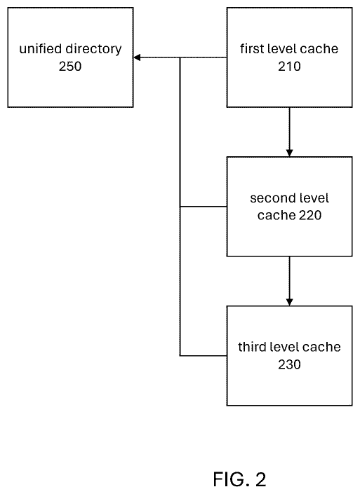

In some embodiment, multiple directory structures may be present in the overall cache hierarchy, which may consume memory space as well as routing resources. In some embodiments, the directories present in the inclusive and exclusive caches in a cache hierarchy may be combined into a single unified cache directory that tracks all data elements present across all levels of the cache hierarchy. A unified cache directory will be described in more detail below with reference to FIG. 2.

FIG. 2 illustrates an example embodiment of a multi-level cache with a unified cache directory in accordance with embodiments of the disclosure. In FIG. 2, the first level cache 210, second level cache 220, and third level cache 230 are similar elements to the first level cache 110, second level cache 120, and third level cache 130 in FIG. 1.

In some embodiments, a unified directory 250 may be used to track all data elements present across all levels of the cache hierarchy. In some embodiments, the unified directory 250 may contain an indicator of a cache where the data is present in the cache hierarchy. In some embodiments, caches at a same level of the cache hierarchy may be ordered and/or the unified directory 250 may indicate in which cache the data is present. Thus, in some embodiments, the unified directory 250 may simplify cache miss resolution since the directory may be checked once to determine if the data is in the cache hierarchy. Furthermore, in some embodiments, faster resolution/identification of local home node (e.g., node where the memory location and the directory entry of an address reside) may be provided in cases where a distributed cache directory organization is utilized.

In some embodiments, a directory entry may consist of <cache_presence_bit, state_info, metadata> for each level of cache. In some embodiments, the cache_presence_bit may indicate the location or level of the data in the cache. In some embodiments, the additional bits required per entry may not increase cache directory size significantly. In some embodiments, when using a unified cache directory, a single directory lookup may provide information about which levels of the cache hierarchy the data is present and help with faster resolution of cache misses.

In some embodiments, a tag lookup may occur in the first level cache 210 to determine if data is present in the first level cache 210. If the data is present in the first cache, it may be returned from the first level cache 210. In some embodiments, if the data is not present in the first level cache 210, it may be considered a cache miss, and a unified cache directory lookup and/or a second level cache tag lookup may be performed. In some embodiments, the two operations may be done in serial or in parallel. In some embodiments, when the unified directory 250 is accessed, the data may be identified if it is present in a second level cache 220 or third level cache 230. In some embodiments, if the data is present in the second level cache 220, by performing the second level cache tag lookup in parallel with the unified cache directory lookup, additional latency may not be incurred since the operations are performed in parallel. Furthermore, in some embodiments, if the operations are performed in serial, only the cache directory lookup may need to be performed. Thus, in some embodiments, a second level cache tag lookup is performed if the data is found in the unified cache directory. In some embodiments, if the data is identified to be present in the third level cache 130, at the end of the unified cache directory lookup, a third level cache tag lookup may be performed to resolve the cache miss from the second level cache 220. In some embodiments, if the data is not present in any of the caches (e.g., the data is not found in the unified cache directory lookup), the third level cache tag lookup need not be performed and main memory access may be initiated, improving the latency for overall resolution of the cache miss.

In some embodiments, to send a request to the main memory for data, if the unified cache directory lookup and a second level cache tag lookup are performed in parallel, a unified cache directory lookup and a second level cache tag lookup may be performed. The result is a savings of one cache directory lookup and a third level cache tag lookup as compared to the cache hierarchy in FIG. 1, resulting in energy and latency savings for main memory access and cache miss resolution. In some embodiments, to send a request to the main memory for access, if the unified cache directory lookup and a second level cache tag lookup are performed in serial (e.g., the unified cache directory lookup is performed first), a unified cache directory lookup may be performed before sending a request to the main memory for data.

In some embodiments, a processor may have a combination of unified caches and non-unified cache directories. For example, although a unified cache directory may save cache space and processing, a non-unified cache directory may be used for caches that are dedicated to an application or otherwise require direct access to that cache.

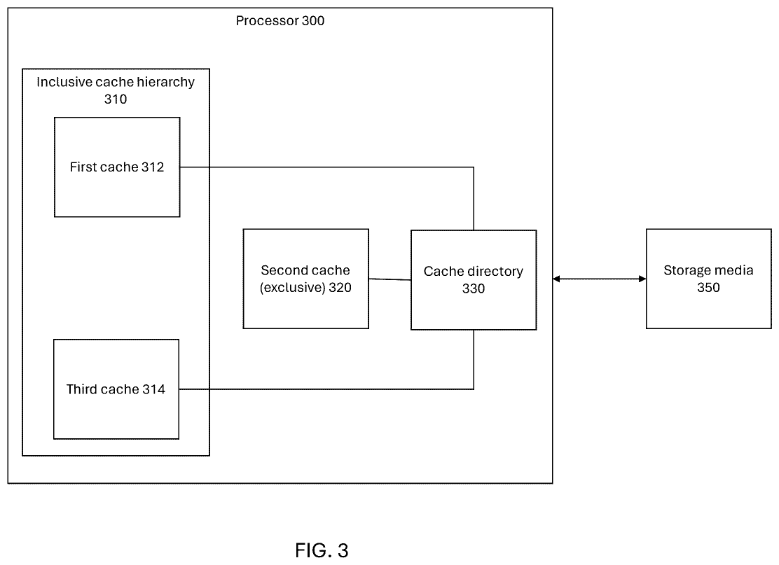

FIG. 3 illustrates an example device including a cache directory in accordance with example embodiments of the disclosure. The device in FIG. 3 includes a processor 300 and storage media 350. The processor 300 includes an inclusive cache hierarchy 310, an exclusive cache (e.g., second cache 320), and a cache directory 330. The inclusive cache hierarchy includes a first cache 312 and a third cache 314. In the example of FIG. 3, the first cache 312 may be fast memory. In some embodiments, when the processor retrieves data, the first cache may be searched. In some embodiments, if the data is found in the first cache, the data can be returned from the first cache. In some embodiments, since this may require a single cache tag lookup to the first cache and the cache may be fast memory, the retrieval of data form the first cache may be fast.

In some embodiments, if the data is not found on the first cache 312, the second cache 320 and cache directory 330 may be searched. In some embodiments, in the cache hierarchy, the second cache 320 may be a second level cache. In some embodiments, the second cache 320 may be an exclusive cache. In some embodiments, the second cache 320 and cache directory 330 may be searched in parallel. In some embodiments, the cache directory 330 may be searched first and if the data is found in the cache directory 330, the cache where the data is located may be searched. In some embodiments, since the cache directory 330 indicates a location of the data in the inclusive and exclusive caches, if an entry is found in the cache directory 330, the data may be retrieved from the cache hierarchy. For example, an entry in the cache directory may indicate that the data is located in the third cache 314. The data may then be retrieved from the third cache 314 (e.g., third level cache tag lookup) without performing another directory lookup. In some embodiments, if an entry for the data is not found in the cache directory 330, the data may not be located in the cache hierarchy and may retrieved from the storage media 350. In some embodiments, since the data was not found in the cache directory 330, the third cache 314 or another directory may not need to be searched, reducing the time needed for the processor to retrieve data.

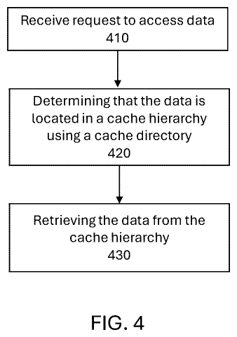

FIG. 4 illustrates a flowchart of a method where data is found in a unified cache directory in accordance with example embodiments of the disclosure.

At 410, in some embodiments, a request to access data may be received. For example, a processor core may request data from a cache hierarchy. In some embodiments, the cache hierarchy may contain both inclusive and exclusive caches, and a cache directory that indicates the presence of data in the inclusive and exclusive caches. In some embodiments, the inclusive and exclusive caches may be organized in a hierarchy structure. For example, a first cache may be a first level cache, a second cache may be a second level cache, and a third cache may be a third level cache.

At 420, using the cache directory, it may be determined that the data is located in the cache hierarchy. For example, the cache directory may contain entries for all of the data present in the cache hierarchy. In some embodiments, if the data is located in a third level cache, the cache directory may have a corresponding entry indicating where the data is located.

At 430, data may be retrieved from the cache directory. For example, if the cache directory indicates that the data is located in a third level cache, a third level cache lookup may be performed, and the data may be returned from the third level cache.

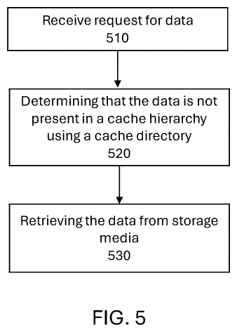

FIG. 5 illustrates a flowchart of a method where data is not found in a unified cache directory in accordance with example embodiments of the disclosure.

At 510, in some embodiments, a request for data may be received. For example, a processor core may request data from a cache hierarchy. In some embodiments, the cache hierarchy may contain both inclusive and exclusive caches, and a cache directory that indicates the presence of data in the inclusive and exclusive caches. In some embodiments, the inclusive and exclusive caches may be organized in a hierarchy structure. For example, a first cache may be a first level cache, a second cache may be a second level cache, and a third cache may be a third level cache.

At 520, using the cache directory, it may be determined that the data is not present in the cache hierarchy. For example, the cache directory may contain entries for all of the data present in the cache hierarchy. In some embodiments, if the data is not located in the cache hierarchy, the cache directory may not have a corresponding entry indicating where the data is located. Thus, by searching the cache directory, the process may identify that the data is not located in the cache hierarchy without performing cache tag lookups.

At 530, data may be retrieved from the storage media. For example, if the cache directory indicates that the data is not located I the cache hierarchy, instead of searching each level of cache, the data may be returned from the storage media. This allows for fewer operations to retrieve the data from the storage media.

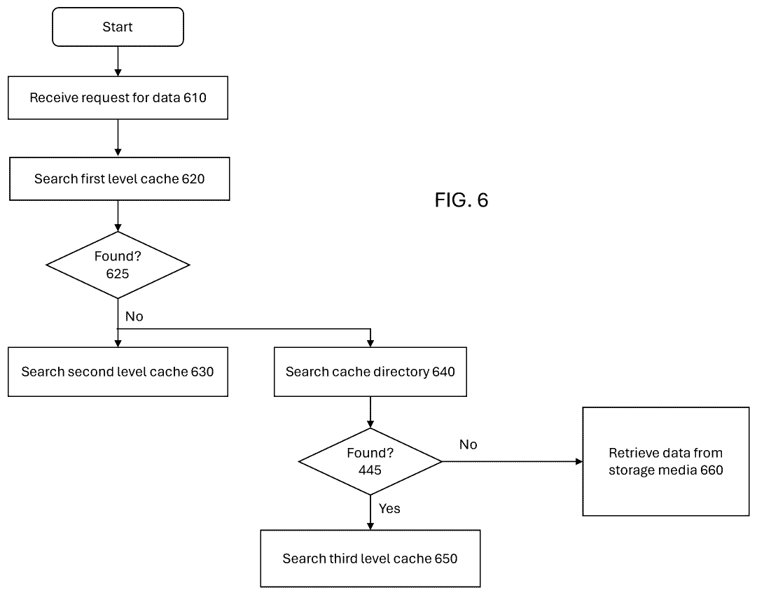

FIG. 6 illustrates a flowchart of a method for searching the unified cache directory in accordance with example embodiments of the disclosure.

In some embodiments, at 610, a cache media may receive a request for data. In some embodiments, for a core of a multi-core processor, the core may not know if the data is present in cache media or storage media. Thus, the cache media may receive the request to determine if it may handle the request.

In some embodiments, the first level cache for the core may be searched (620). In some embodiments, the cache media may perform a cache tag lookup on the first level cache. In some embodiments, if the data is found in the first level cache (625), the data may be returned from the cache (e.g., first level cache).

In some embodiments, if the data is not found in the first level cache, the second level cache (630) and the cache directory (640) may be searched. In some embodiments, if the data is found in the second level cache, the data may be returned from the second level cache. In some embodiments, searching of second level cache 630 and searching of the cache directory 640 may be done in parallel. Thus, since the steps may be performed in parallel (e.g., the unified directory may be searched while searching the second level cache), latency of data retrieval from the cache due to cache misses may be reduced. In some embodiments, the cache directory may be searched first. Thus, if an entry is found in the cache directory, the cache where the directory is located may be searched. In some embodiments, the cache directory may contain the location of all data across the cache hierarchy. Thus, in some embodiments, the cache directory may contain entries for the first level cache (e.g., inclusive cache hierarchy with the last level cache), second level caches (e.g., exclusive caches), and third level caches (e.g., last level cache).

If data is found in the cache directory (645), for example, the data is on the third level cache, the third level cache may be searched (650), e.g., a third level cache tag lookup may be performed. In some embodiments, when the data is found in the third level cache, the data may be returned from the third level cache. Data may be found at any level of the cache media, and searching the third level cache 650 is described for illustrative purposes. For example, the cache directory may indicate that the data may be found at another second level cache or a fourth level cache, etc. Thus, the cache directory may indicate the level of cache where the data is located, and the caches at that level may be searched for the data.

If the data is not found on the unified directory, the data may be retrieved from the storage media (660). Thus, in some embodiments, only a single directory lookup may be performed to search the cache media for data instead of a directory lookup for each level of cache.

The principles disclosed herein have independent utility and may be embodied individually, and not every embodiment may utilize every principle. However, the principles may also be embodied in various combinations, some of which may amplify the benefits of the individual principles in a synergistic manner.

For purposes of illustrating the inventive principles of the disclosure, some example embodiments may be described in the context of specific implementation details such as a processing system that may implement a NUMA architecture, memory devices, and/or pools that may be connected to a processing system using an interconnect interface and/or protocol Compute Express Link (CXL), and/or the like. However, the principles are not limited to these example details and may be implemented using any other type of system architecture, interfaces, protocols, and/or the like.

In some embodiments, the latency of a memory device may refer to the delay between a memory device and the processor in accessing memory. Furthermore, latency may include delays caused by hardware such as the read-write speeds to access a memory device, and/or the structure of an arrayed memory device producing individual delays in reaching the individual elements of the array. For example, a first memory device in the form of DRAM may have a faster read/write speed than a second memory device in the form of a NAND device. Furthermore, the latency of a memory device may change over time based on conditions such as the relative network load, as well as performance of the memory device over time, and environmental factors such as changing temperature influencing delays on the signal path.

Although some example embodiments may be described in the context of specific implementation details such as a processing system that may implement a NUMA architecture, memory devices, and/or pools that may be connected to a processing system using an interconnect interface and/or protocol CXL, and/or the like, the principles are not limited to these example details and may be implemented using any other type of system architecture, interfaces, protocols, and/or the like. For example, in some embodiments, one or more memory devices may be connected using any type of interface and/or protocol including Peripheral Component Interconnect Express (PCIe), Nonvolatile Memory Express (NVMe), NVMe-over-fabric (NVMe oF), Advanced extensible Interface (AXI), Ultra Path Interconnect (UPI), Ethernet, Transmission Control Protocol/Internet Protocol (TCP/IP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, and/or the like, or any combination thereof. In some embodiments, an interconnect interface may be implemented with one or more memory semantic and/or memory coherent interfaces and/or protocols including one or more CXL protocols such as CXL.mem, CXL.io, and/or CXL.cache, Gen-Z, Coherent Accelerator Processor Interface (CAPI), Cache Coherent Interconnect for Accelerators (CCIX), and/or the like, or any combination thereof. Any of the memory devices may be implemented with one or more of any type of memory device interface including DDR, DDR2, DDR3, DDR4, DDR5, LPDDRX, Open Memory Interface (OMI), NVLink, High Bandwidth Memory (HBM), HBM2, HBM3, and/or the like.

In some embodiments, any of the memory devices, memory pools, hosts, and/or the like, or components thereof, may be implemented in any physical and/or electrical configuration and/or form factor such as a free-standing apparatus, an add-in card such as a PCIe adapter or expansion card, a plug-in device, for example, that may plug into a connector and/or slot of a server chassis (e.g., a connector on a backplane and/or a midplane of a server or other apparatus), and/or the like. In some embodiments, any of the memory devices, memory pools, hosts, and/or the like, or components thereof, may be implemented in a form factor for a storage device such as 3.5 inch, 2.5 inch, 1.8 inch, M.2, Enterprise and Data Center SSD Form Factor (EDSFF), NF1, and/or the like, using any connector configuration for the interconnect interface such as a SATA connector, SCSI connector, SAS connector, M.2 connector, U.2 connector, U.3 connector, and/or the like. Any of the devices disclosed herein may be implemented entirely or partially with, and/or used in connection with, a server chassis, server rack, dataroom, datacenter, edge datacenter, mobile edge datacenter, and/or any combinations thereof. In some embodiments, any of the memory devices, memory pools, hosts, and/or the like, or components thereof, may be implemented as a CXL Type-1 device, a CXL Type-2 device, a CXL Type-3 device, and/or the like.

In some embodiments, any of the functionality described herein, including, for example, any of the logic to implement tiering, device selection, and/or the like, may be implemented with hardware, software, or a combination thereof including combinational logic, sequential logic, one or more timers, counters, registers, and/or state machines, one or more complex programmable logic devices (CPLDs), field programmable gate arrays (FPGAs), application specific integrated circuits (ASICs), central processing units (CPUs) such as complex instruction set computer (CISC) processors such as x86 processors and/or reduced instruction set computer (RISC) processors such as ARM processors, graphics processing units (GPUs), neural processing units (NPUs), tensor processing units (TPUs) and/or the like, executing instructions stored in any type of memory, or any combination thereof. In some embodiments, one or more components may be implemented as a system-on-chip (SOC).

In this disclosure, numerous specific details are set forth in order to provide a thorough understanding of the disclosure, but the disclosed aspects may be practiced without these specific details. In other instances, well-known methods, procedures, components, and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” may include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

The term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system-on-a-chip (SoC), an assembly, and so forth. Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, e.g., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

While certain exemplary embodiments have been described and shown in the accompanying drawings, it should be understood that such embodiments merely illustrative, and the scope of this disclosure is not limited to the embodiments described or illustrated herein. The invention may be modified in arrangement and detail without departing from the inventive concepts, and such changes and modifications are considered to fall within the scope of the following claims.

1. A device comprising:
a storage media; and
a processor comprising:
a cache hierarchy comprising a first cache, a second cache, and a third cache; wherein the first cache and the third cache are organized in an inclusive cache hierarchy; and wherein the second cache is an exclusive cache to the inclusive cache hierarchy; and
a cache directory, wherein the cache directory corresponds to the first cache, second cache, and third cache.

2. The device of claim 1, wherein the first cache is a first level cache, the second cache is a second level cache, and the third cache is a last level cache.

3. The device of claim 1, wherein an entry of the cache directory comprises an indicator of a cache where data is present in the cache hierarchy.

4. The device of claim 1, wherein the processor performs operations comprising:
searching the first cache for data;
searching the second cache for the data; and
searching the cache directory for the data.

5. The device of claim 4, wherein searching the second cache and searching the cache directory are performed in parallel.

6. The device of claim 1, wherein the processor performs operations comprising:
requesting data;
determining that the data is located in the cache directory; and
determining a location of the data in the cache hierarchy based on an entry in the cache directory.

7. The device of claim 1, wherein the processor performs operations comprising:
requesting data;
determining that the data is not found in the cache directory; and
retrieving data from the storage media.

8. The device of claim 1, further comprising a fourth cache;
wherein the first cache is a first level cache;
wherein the second cache and the fourth cache are second level caches;
wherein the third cache is a last level cache;
wherein the fourth cache is an exclusive cache; and
wherein the processor performs operations comprising:
searching the cache directory for data;
determining that the data is found in a second level cache; and
searching the fourth cache for the data.

9. The device of claim 1, further comprising a fourth cache;
wherein the first cache is a first level cache;
wherein the second cache is a second level cache;
wherein the third cache and the fourth cache are last level caches;
wherein the fourth cache is organized in the inclusive cache hierarchy; and
wherein the processor performs operations comprising:
searching the cache directory for data;
determining that the data is found in a last level cache; and
searching the fourth cache for the data.

10. A method implemented by a processor comprising cache media;
wherein the cache media comprises a cache hierarchy and a cache directory; and
wherein the method comprises:
receiving a request to access data;
determining, using the cache directory, that the data is located in the cache hierarchy, wherein the cache hierarchy comprises one or more inclusive caches and one or more exclusive caches, wherein the cache hierarchy is organized in a hierarchy structure; and
retrieving the data from the cache hierarchy.

11. The method of claim 10,
wherein the cache hierarchy comprises a first level cache, second level cache, and third level cache; and
wherein determining that the data is located in the cache hierarchy comprises:
searching the first level cache for the data;
searching the second level cache for the data;
searching the cache directory for the data;
determining, by the cache directory, that the data is located at the third level cache; and
searching the third level cache for the data.

12. The method of claim 11, wherein searching the second level cache and searching the cache directory are performed in parallel.

13. The method of claim 10, wherein the method further comprises:
determining that the data is located in the cache directory; and
determining a location of the data in the cache hierarchy based on the cache directory.

14. The method of claim 10, wherein the cache directory comprises an indicator of a cache where the data is present in the cache hierarchy.

15. The method of claim 10,
wherein the one or more inclusive caches comprises a first cache and a third cache;
wherein the one or more exclusive caches comprises a second cache and a fourth cache;
wherein the first cache is a first level cache;
wherein the second cache and the fourth cache are second level caches; and
wherein determining that the data is located in the cache hierarchy comprises:
searching the first cache for the data;
searching the second cache and the cache directory for the data;
determining, by the cache directory, that the data is located at a different cache at a second level cache; and
searching the fourth cache for the data.

16. The method of claim 10, wherein determining that the data is located in the cache hierarchy comprises:
searching the cache directory for the data; and
determining a location of the data based on an indicator of a cache where the data is present in the cache hierarchy.

17. A method implemented by a processor comprising cache media;
wherein the cache media comprises a cache hierarchy and a cache directory; and
wherein the method comprises:
receiving a request for data;
determining, using the cache directory, that the data is not present in the cache hierarchy, wherein the cache hierarchy comprises one or more inclusive caches and one or more exclusive caches, and wherein the cache hierarchy is organized in a hierarchy structure; and
retrieving the data from storage media.

18. The method of claim 17,
wherein the cache hierarchy comprises a first level cache and a second level cache; and
wherein determining that the data is not present in the cache hierarchy comprises:
searching the first level cache for the data;
searching the second level cache for the data; and
searching the cache directory for the data, wherein the data does not include a corresponding entry in the cache directory.

19. The method of claim 18, wherein searching the second level cache and searching the cache directory are performed in parallel.

20. The method of claim 18, wherein searching the cache directory comprises determining that the data is not located in the cache directory.
